(19) United States
(12) Patent Application Publication
(10) Pub. No.: US 2009/0004073 A1
(43) Pub. Date: Jan. 1, 2009

(54) Catalytic Filter Having a Short Light-Off Time

(75) Inventors: Vincent Marc Gleize, Avignon (FR); David Pinturaud, Corailln (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GONAIN CNETRE DE RECHERCHES ET D'ET EUROPEEN, COURBEVOIE (FR)

(21) Appl. No.: 12/162,859

(22) PCT Filed: Jan. 31, 2007
(86) PCT No.: PCT/FR2007/050712

§ 371 Date: Jul. 31, 2008

(30) Foreign Application Priority Data
Jan. 31, 2006 (FR) 0650347

(51) Int. Cl. B01D 53/86; B29C 65/00

(52) U.S. Cl. 422/180; 156/60; 425/382 N

(57) ABSTRACT

The invention relates to a catalytic filter for the treatment of a gas laden with soot and pollutant particles in a gas phase, comprising a plurality of monolithic honeycomb blocks connected together by a jointing cement, the thermal conductivity of which is greater than 0.3 W/m.K, said filter being characterized in that at least the monolithic blocks placed in the central part of the filter, and preferably all of the monolithic blocks, have, along a radial direction, a peripheral portion whose total filtration area is greater than the total filtration area of the central portion of said blocks.

The invention relates to the field of particulate filters, used in particular in an engine exhaust line to remove the soot produced by the combustion of a diesel fuel in an internal combustion engine. More precisely, the invention relates to a particulate filter incorporating a component giving it catalytic properties, and to a method for fabricating said filter.

Structures for filtering the soot contained in the exhaust gases of an internal combustion engine are well known from the prior art. These structures usually have a honeycomb structure, one side of the structure for drawing in the exhaust gases to be filtered and the other side for discharging the filtered exhaust gases. Between the intake and discharge sides, the structure comprises a series of adjacent passages or channels having axes parallel to one another separated by porous filtration walls, said passages being blocked at one or the other of their ends to bound inlet passages opening along the intake side and outlet passages opening along the discharge side. For proper gastightness, the peripheral part of the structure is usually surrounded by a coating cement. The channels are alternately blocked in an order such that the exhaust gases, during the passage through the honeycomb body, are forced to cross the side walls of the inlet channels to reach the outlet channels. In this way, the particulates or soot are deposited and accumulate on the porous walls of the filter body. The filter bodies are usually made from a porous ceramic material, for example from cordierite or from silicon carbide.

In a manner known per se, during its use, the particulate filter is subject to a succession of filtration (accumulation of soot) and regeneration (removal of the soot) phases. During the filtration phases, the soot particulates emitted by the engine are retained and deposit inside the filter. During the regeneration phases, the soot particulates are burned inside the filter, so as to restore its filtration properties. The porous structure is then subjected to intense thermomechanical stresses, which can cause microcracks which, over time, are liable to cause a severe loss of the filtration capacities of the unit, or even its complete deactivation. This process is observed in particular on large-diameter monolithic filters. In operation in an exhaust line, it has in fact been observed that the thermal gradient between the center and the periphery of such structures is commensurately higher as the dimensions of the monolith are larger.

To solve these problems and to lengthen the service life of the filters, filtration structures were recently proposed combining a plurality of monolithic honeycomb blocks or elements. The elements are usually joined together by bonding using a ceramic adhesive or cement, called jointing cement in the rest of the description. Examples of such filter structures are described for example in patent applications EP 816 065, EP 1 142 619, EP 1 455 923, WO 2004/090294 and also WO 2005/063462. To ensure a better stress relief in an assembled structure, it is known that the thermal expansion coefficients of the various parts of the structure (filtration elements, coating cement, jointing cement) must be substantially similar. Accordingly, said parts are advantageously synthesized on the basis of the same material, usually silicon carbide SiC or cordierite. This choice also serves to make the heat distribution uniform during the regeneration of the filter. In the context of the present description, the expression “on the basis of the same material” means that the material consists of at least 25% by weight, preferably at least 45% by weight and most preferably at least 70% by weight of said material. In the context of the present invention, the choice of using the same basic material for the various parts of the filter must, however, not be considered as the only advantageous embodiment, and other embodiments, comprising in particular the combination of various materials, are also encompassed within the scope of the present invention.

To improve the thermomechanical strength of the filters, patent application EP 1 413 344 proposes elements in which the central part has a higher heat capacity than the peripheral part, due to higher cell wall thicknesses at the periphery than at the center of an element. According to this prior art, such a configuration serves to reduce the thermal stresses on the filter during the regeneration phases, that is when the filter is heated to a temperature close to 600° C. (450° C. in the presence of certain additives in the diesel fuel). According to this prior art, the filtration area accessible to the gases is therefore smaller at the periphery of the element than at the center thereof.

Also in order to reduce the thermomechanical stresses appearing during the regeneration phases, patent application WO 02/081878 describes filtration blocks for solid soot particulates, comprising at least two zones having different filtration areas.

The filters or porous soot filtration structures as previously described are mainly used on a large scale in pollution prevention devices for the exhaust gases of a diesel internal combustion engine. In this type of application, it is also known that the introduction of a particulate filter as previously described into the exhaust line of the engine causes a pressure drop that is liable to lower the performance thereof. The filter must consequently be adapted to avoid such a deterioration.

In addition to the problem of soot treatment, the conversion of the gas phase pollutant emissions (that is mainly carbon monoxide (CO) and unburnt hydrocarbons (HC) and even nitrogen oxides (NOₓ) and sulfur oxides (SOₓ)) to less harmful gases (such as water vapor, carbon dioxide (CO₂) or nitrogen gas (N₂)) requires an additional catalytic treatment. The most advanced filters today therefore have an additional catalytic component. According to the methods conventionally used, the catalytic function is obtained by impregnating the honeycomb structure with a solution comprising the catalyst or a precursor of the catalyst, generally based on a precious metal of the platinum group.

Such catalytic filters are highly effective for the treatment of the pollutant gases when the temperature reached in the filter is higher than the catalyst light-off temperature. This temperature is usually defined, in given gas pressure and flow rate conditions, as the temperature at which a catalyst converts 50% by volume of the pollutant gases HC and CO. Depending on the gas pressure and flow rate conditions, this temperature generally varies, for an SiC based filter comprising the catalyst based on a noble metal of the conventionally used platinum family, between about 100° C. and about 240° C.

When the temperature of the catalyst is lower than the light-off temperature, the conversion rates are extremely low, explaining why most of the pollutant gas emissions from present-day engines are emitted during cold starting, more particularly during the first few minutes of the use of the vehicle. This period corresponds as a first approximation to the time required for the cold filter to reach substantially, on average and throughout this volume, the catalyst light-off temperature. In the context of the present description, said period is defined, by analogy with the light-off temperature previously described, as the light-off time, and is characteristic of a given filter and of the catalyst used.

Related to the number of vehicles in circulation, it is quite obvious that a decrease in this time, even minimal, for example of about one second, would serve to very substantially reduce the gaseous pollutant emissions, and would therefore reflect considerable technical progress.

However, it is essential for such a decrease to avoid causing a substantial deterioration in the other properties characterizing the filter in operation, that is mainly the pressure drop generated in the exhaust line and the thermomechanical strength, as they have been previously defined.

The invention relates to a catalytic filter for the treatment of a gas laden with soot and pollutant particulates in a gas phase, having a short light-off time, while maintaining a pressure drop and a thermomechanical strength making it suitable for its use in an exhaust line. More precisely, the catalytic filter comprises a plurality of monolithic honeycomb blocks connected together by a jointing cement, the thermal conductivity of which is greater than 0.3 W/m.K. The blocks comprise a series of adjacent passages or channels having axes parallel to one another separated by porous walls, said passages being blocked by plugs at one or the other of their ends to bound inlet passages opening along a gas intake side and outlet passages opening along a gas discharge side, in such a way that the gas crosses the porous walls. Said filter is characterized in that at least the monolithic blocks placed in the central part of the filter, and preferably all of the monolithic blocks, have, along a radial direction, a peripheral portion whose total filtration area is greater than the total filtration area of a central portion of said blocks. Obviously, said peripheral and central portions, to be comparable, have a similar size, that is an identical volume, but are differentiated by a different gas filtration area inside said same volume.

In the context of the present description, total filtration area of a central or peripheral portion of a monolithic block means the total area of the walls encompassed in the volume element constituting said central or peripheral portion and allowing the filtration of the gases entering said block.

According to a preferred embodiment, said elements and the jointing cement are based on the same ceramic material, preferably based on silicon carbide SiC.

In general, the thickness of the joint between the blocks is between 0.1 mm and 6 mm, preferably between 0.1 and 3 mm.

The jointing cement typically has a thermal conductivity of between 0.3 and 20 W/m.K, preferably between 1 and 5 W/m.K.

According to a particular embodiment of the catalytic filter according to the invention, the density of the channels of the peripheral portion of the blocks is higher than the density of the channels of the central portion of the blocks. Preferably in this case, the thickness of the channel walls of the peripheral portion of the blocks is less than the thickness of the channel walls of the central portion of the blocks.

According to another particular embodiment of the catalytic filter according to the invention, the opening area of the channels of the peripheral portion of the blocks is greater than the opening area of the channels of the central portion of the blocks.

For example, the channels present in the central portion of the blocks have a substantially square cross section and the channels of the peripheral portion of the blocks are characterized by a wavy shape.

Typically, according to the invention, the ratio of the filtration area of the peripheral portion to the filtration area of the central portion is between 1.1 and 5.

The increase in the filtration area from the center toward the periphery of the block, in the catalytic filters according to the invention, can be obtained either by the presence of at least two distinct and advantageously concentric zones, whose respective filtration areas are different, or by a gradual increase in said area over the whole cross section of the block.

The invention also relates to the extrusion die conformed so as to form, by extrusion of a ceramic material, a monolithic block provided with channels suitable for producing a catalytic filter as previously described.

The invention further relates to a method for fabricating a catalytic filter comprising a plurality of monolithic honeycomb blocks connected together by a jointing cement, the thermal conductivity of which is greater than 0.3 W/m.K, in which the geometry of the channels and/or their density and/or the thickness of the channel walls is adjusted between the central part and the peripheral part, to shorten the light-off time of the gas conversion reaction.

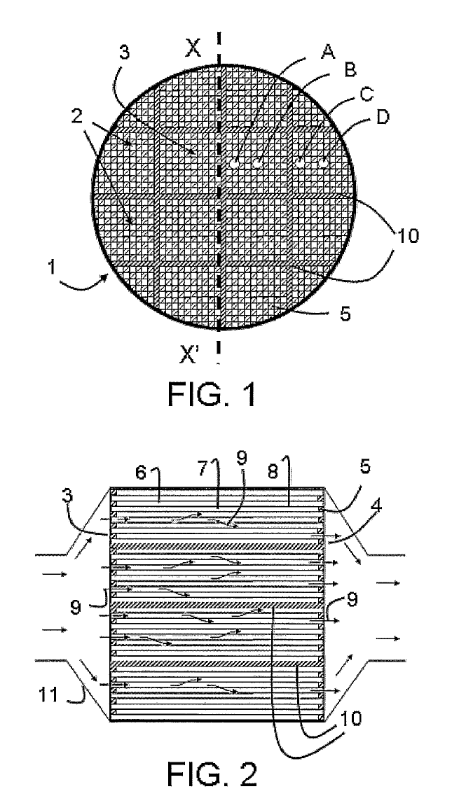

The invention will be better understood from a reading of the description of various embodiments of the invention that follow, illustrated respectively by FIGS. 1 to 4.

FIG. 1 shows a schematic view of the upstream side of a filter assembled according to the prior art.

FIG. 2 shows a cross section along X-X′ of the filter in FIG. 1, placed in a metal housing.

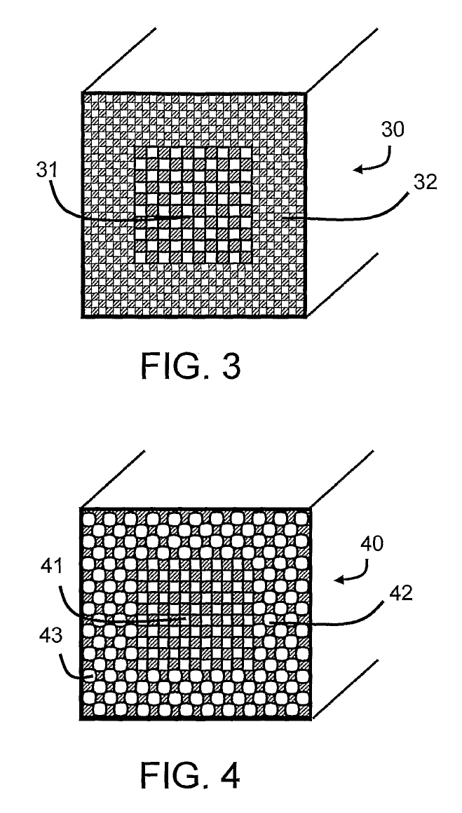

FIG. 3 shows a perspective view of a monolithic block around the upstream gas inlet side, according to a first embodiment of the invention.

FIG. 4 shows a perspective view of a monolithic block along the upstream gas inlet side, according to a second embodiment of the invention.

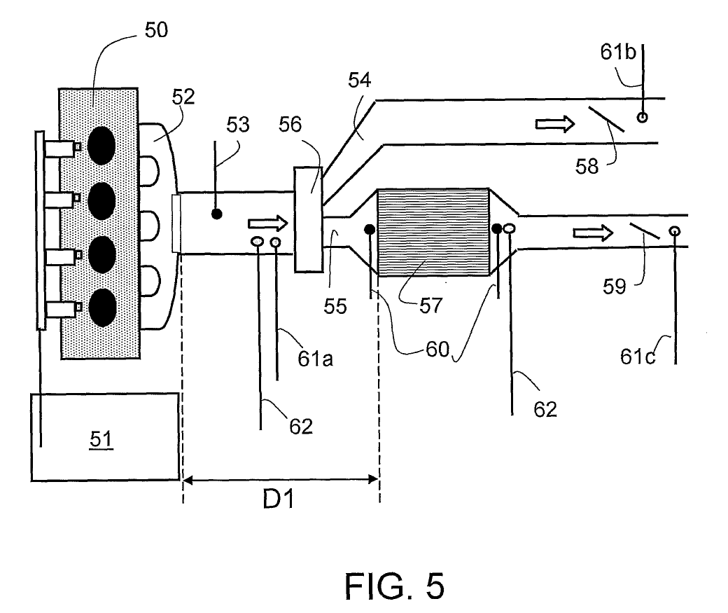

FIG. 5 is a schematic illustration of the device used to measure the light-off time of the catalytic filters.

FIGS. 1 and 2 describe an assembled filter 1 according to the prior art. In a manner known per se, the filter is obtained by joining monolithic blocks 2. The monolithic blocks 2 are themselves obtained by extrusion of a loose slurry, for example of silicon carbide, to form a porous honeycomb structure.

Without this being considered as restrictive, the porous structure extruded in the form of monolithic blocks has the shape of a rectangular parallelepiped in FIGS. 1 to 4, extending along a longitudinal axis between two substantially square upstream 3 and downstream 4 sides on which terminate a plurality of adjacent channels, straight and parallel to the longitudinal axis.

The extruded porous structures are alternately plugged on their upstream side 3 or their downstream side 4 by upstream and downstream plugs 5, to form outlet channels 6 and inlet channels 7 respectively.

Each channel 6 or 7 thereby defines an internal volume bounded by side walls 8, a plug 5 placed either on the upstream side, or on the downstream side, and an opening terminating alternately toward the downstream side or the upstream side, in such a way that the inlet and outlet channels are in fluid communication via the side walls 8.

The 16 monolithic blocks are joined together by bonding using a ceramic jointing cement 10, for example also based on silicon carbide, into a filtration structure or filter assembled as shown in FIGS. 1 and 2. The assembly thereby formed can then be machined to have a round or ovoid cross section, for example, and then covered with a coating cement.

This produces an assembled filter suitable for being inserted into an exhaust line 11, according to well-known techniques.

In operation, the exhaust gas stream F enters the filter 1 via the inlet channels 7, then crosses the filtering side walls 8 of these channels to reach the outlet channels 6. The propagation of the gases in the filter is shown in FIG. 2 by arrows 9.

FIG. 3 shows a first embodiment of the invention of a block comprising two distinct zones. According to this embodiment, the density of the channels, having a substantially square cross section, of a monolithic block, is variable between the central part and the peripheral part.

The monolithic block 30 conventionally comprises a central part 31 characterized by a first channel density per unit area and a peripheral part 32 characterized by a second channel density per unit area that is higher than that of the central part.

Typically, according to this embodiment, the channel density of the filter is between 6 and 1800 cpsi (channels per square inch, or between about 1 and about 280 channels per cm²), preferably between 90 and 400 cpsi (or between about 14 and about 62 channels per cm²).

For example, according to this embodiment, the ratio of the cell density between the two zones, that is the ratio of the cell density in the peripheral part to the cell density in the central part, is between 1.1 and 5.

FIG. 4 shows another embodiment of the invention in which the channel geometry is variable between the central part and the peripheral part.

The block 40 conventionally comprises a central part 41 in which the channels have a cross section having a substantially square shape and a peripheral part 42 in which the inlet channels 43 have a cross section the shape of which conforms to the teaching of application WO 2005/016491. According to this embodiment, the wall elements in the peripheral part 42 succeed one another, in transverse section and along a horizontal or vertical row of channels, to define a wavy or sinusoidal shape, as shown in FIG. 4. The wall elements undulate by a half-sine period over the width of a channel.

Typically, in this embodiment, the channel density of the central and peripheral parts is identical and is between 6 and 1800 cpsi, preferably between 90 and 400 cpsi.

In this embodiment, on the upstream side of the block in FIG. 4, the ratio of the area of the peripheral part to the area of the central part is between 1.1 and 5.

The invention will be better understood from a reading of the following examples, provided purely for illustration.

### EXAMPLE 1

### According to the Prior Art

Filter structures were synthesized comprising an assembly of monolithic blocks of silicon carbide joined by a jointing cement as shown in FIGS. 1 and 2, according to the techniques described in patent EP 1 142 619.

More precisely, sixteen monolithic square section filter elements are first extruded, from an initial mixture of silicon carbide powders, a pore-forming agent of the polyethylene type and an organic binder of the methylcellulose type.

Water is added to the initial mixture, followed by mixing until a uniform slurry is obtained having a plasticity suitable for extrusion through a die of monolithic honeycomb structures whose dimensional characteristics are given in Table 1 below. The die used is configured conventionally so that all the channels of the monolithic block obtained at the outlet of the die have substantially the same dimensions and shape.

The green monoliths obtained are then dried by microwave for a time sufficient to lower the content of non-chemically bound water to less than 1% by weight. The channels of each side of the monolith are then alternately plugged by well-known techniques, described for example in application WO 2004/065088.

The monolithic block is then fired with a temperature rise of 20° C./hour until reaching a temperature of about 2200° C., which is held for five hours.

The elements issuing from the same mixture are then joined together by bonding using a cement having the following chemical composition: 72 wt % SiC, 15 wt % Al₂O₃, 11 wt % SiO₂, the remainder consisting of impurities, mainly Fe₂O₃ and oxides of alkali and alkaline-earth metals. The average thickness of the joint between two neighboring blocks is about 2 mm. The thermal conductivity of the jointing cement is about 2.1 W/m.K at ambient temperature and its measured open porosity is about 38%.

The assembly is then machined to form cylindrical assembled filters.

The filters thus produced have a uniform filtration area along a radial direction of 0.84 m²/liter of filter block.

According to conventional techniques for depositing the conversion catalyst for pollutant gases, the filter is then impregnated with a catalytic solution comprising platinum, and then dried and heated. The chemical analysis shows a total Pt concentration of 40 g/ft³ (1 g/ft³=0.035 kg/m³), or 3.46 grams uniformly distributed on the various parts of the filter.

### EXAMPLE 2

### According to the Prior Art

The synthesis technique described in example 1 is repeated identically, but the die is configured this time to obtain monolithic blocks in which the cells have a wavy structure, according to the teaching of application WO 2005/063462.

The monolithic blocks obtained are all identical and are characterized, according to the criteria defined in application WO 2005/016491, by a waviness asymmetry factor of 7%, a ratio r of the total volume of the inlet channels to the total volume of the outlet channels of 1.72, and a filtration area of 0.91 m²/liter of the filter block and a hydraulic diameter of about 1.83 mm. The filters are impregnated with a catalytic solution comprising platinum according to the same technique as previously described and so as to deposit the same weight of platinum uniformly distributed on the various parts of the filter.

The main characteristics of the filters obtained after joining these blocks are given in Table 1.

### EXAMPLE 3

### According to the Invention

The synthesis technique described in example 1 is also repeated identically, but the die is adapted this time so as to produce monolithic blocks in which the radial cell density per unit area at the periphery is higher than the cell density in the central part of the block, as shown in FIG. 3.

The filters are impregnated with a catalytic solution comprising platinum according to the same technique as previously described and in order to deposit the same weight of platinum uniformly distributed on the various parts of the filter.

The main characteristics of the assembled filters obtained according to this example are given in Table 1.

### EXAMPLE 4

### According to the Invention

The synthesis technique described in example 1 is repeated identically, but the die is adapted this time in order to produce monolithic blocks in which the geometry of the channels is different between the central part and the peripheral part, as shown in FIG. 4. The die is configured in such a way that the channels have a square geometry at the center and a wavy geometry at the periphery, of which the characteristic parameters are identical to those described in example 2.

The filters are impregnated with a catalytic solution comprising platinum according to the same technique as previously described and in order to deposit the same weight of platinum uniformly distributed on the various parts of the filter.

The main characteristics of the assembled filters obtained according to this example are given in Table 1.

TABLE 1

| Example | 1 | 2 | 3 | 4 |
|---|---|---|---|---|
| Channel | square | wavy | square | square/Wavy |
| geometry | | | | |
| Channel | 180 cpsi | 180 cpsi | center of | 180 cpsi |
| density | (or 27.9 | | filter: | having the |
| | channels/ | | 180 cpsi | following |
| | cm²) | | (31% of | shape: |
| | | | total area) | at center of |
| | | | periphery | filter: |
| | | | of filter: | square (31% |
| | | | 350 cpsi | of total |
| | | | (69% of | area) |
| | | | total area) | at periphery |
| | | | (54.25 | of filter: |
| | | | channels/cm² | wavy (69% of |
| | | | | total area) |
| Wall | 380 μm | 380 μm | center of | 380 μm |
| thickness | | | filter: | |
| | | | 380 μm | |
| | | | periphery | |
| | | | of filter: | |
| | | | 254 μm | |
| Periodicity | 1.89 mm | 1.89 mm | center of | center of |
| | | | filter: | filter: |
| | | | 1.89 mm | 1.89 mm |
| | | | periphery | periphery of |
| | | | of filter: | filter: |
| | | | 1.35 mm | 1.89 mm |
| Number of | 16 | 16 | 16 | 16 |
| elements | | | | |
| assembled | | | | |
| Shape of | cylindrical | cylindrical | cylindrical | cylindrical |
| assembled | | | | |
| filter | | | | |
| Length | 15.2 cm | 15.2 cm | 15.2 cm | 15.2 cm |
| Volume | 2.47 liters | 2.47 liters | 2.47 liters | 2.47 liters |

The samples in examples 1 to 4 thus obtained were evaluated by three different tests:

A. Measurement of Light-Off Time:

A schematic illustration of the device on the engine test bench used to measure the light-off time of the catalytic filters is given in FIG. 5.

The device comprises a 2.0 L diesel 50 direct injection engine block supplied by a diesel tank 51. The exhaust gases leaving the cylinders are combined in a manifold 52 and discharged in two exhaust lines 54, 55 mounted in parallel. The removal of the gases via one or the other of the lines is managed using a controlled valve 56. The exhaust line 55 comprises the catalytic filter 57 to be analyzed. The distance D1 between the front side of the filter and the end of the manifold is about 80 cm. Butterfly valves 58, 59, placed at the outlet of the lines 54, 55, are used to manage the respective pressure drops of the two lines. The device also comprises various sensors for measuring the temperature (53 and 60), pressure (61) and concentration of the pollutants HC and CO (62) upstream and downstream of the filter.

A test for measuring the light-off time of the filters by the device as described above was carried out on the filters of examples 1 to 4 by the following procedure: the engine is first stabilized at an operating point characterized by an engine speed of 2200 rpm with a maximum deviation of about 2% and a torque of 50 Nm, with a maximum deviation of 2%. The line 55 is closed by the valve 56, the exhaust gases passing entirely through the line 54. The butterfly valve 58, placed at the outlet of the line 54, is partially opened at an angle for maintaining the following conditions:
a temperature variation, measured by the sensor 53, of ±6° C.,
a pressure deviation measured by the sensors 61a and 61b of 60±1.8 mbar (1 bar=10⁵ Pa),
a variation in the gas flow rate of 150±4.5 kg/h, measured by a flowmeter upstream of the intake manifold.

The same procedure is followed on the line 55, the line 54 being closed by the valve 56 and the exhaust gases passing entirely through the line 55.

The butterfly valve 59 placed at the outlet of the line 55 is partially opened at an angle for maintaining the same conditions as previously described:
temperature variation and deviation on either side of the filter ±6° C., measured by the sensors 60,
pressure deviation measured by the sensors 61a and 61c of 60±1.8 mbar,
variation in gas flow rate: 150±4.5 kg/h, measured by a flowmeter upstream of the intake manifold.

After the stabilization of the engine parameters thereby obtained, the valve 56 is controlled in such a way that the line 55 is blocked and the line 54 is opened to the passage of all the exhaust gases issuing from the engine block 51 during at least 15 minutes.

The valve 56 is then controlled in such a way that the line 54 is blocked and the line 55 opened to the passage of all the exhaust gases issuing from the engine block 51.

It is considered that the initial time To of the catalyst light-off period is the time corresponding to the line change and the entry of the gases into the line 55. The curve of the variation in the conversion of the pollutants HC and CO is monitored via sensors 62. One sensor is placed upstream of the filter to measure the pollutant concentration at the filter inlet. Four other sensors, of which the positions are indicated in FIG. 1 by the letters A to D, are placed downstream of the filter, in the gas propagation direction. The light-off time of the catalysts, corresponding to the time required to convert 50% of the volume of the gases, was thus determined for each of the filters. The results obtained for the filters in examples 1 to 4, which are directly comparable, are given in Table 2.

B. Measurement of Pressure Drop:

In the context of the present invention, pressure drop means the differential pressure between the upstream and downstream sides of the filter. The pressure drop was measured by the techniques of the prior art, for an air flow rate of 300 m³/h in an ambient air stream. The results obtained for the filters in examples 1 to 4 are given in Table 2.

C. Measurement of Thermomechanical Strength:

The filters were mounted on an exhaust line of a 2.0 L direct injection diesel engine running at full power (4000 rpm) for 30 minutes, and then dismantled and weighed in order to determine their initial weight. The filters were then mounted on the engine test bench with a speed of 3000 rpm and a torque of 50 Nm for different periods in order to obtain a soot load of 5 g/liter (of filter volume).

The filters laden with soot were remounted on the line to undergo severe regeneration defined as follows: after stabilization at an engine speed of 1700 rpm for a torque of 95 Nm for 2 minutes, a post-injection was carried out with 70° phasing for a post-injection flow rate of 18 mm³/stroke. After initiating the combustion of the soot, more precisely when the pressure drop decreased for at least 4 seconds, the engine speed was reduced to 1050 rpm for a torque of 40 Nm for 5 minutes in order to accelerate the combustion of the soot. The filter was subjected to an engine speed of 4000 rpm for 30 minutes in order to remove the remaining soot.

The regenerated filters were inspected after cutting to identify the presence of any cracks visible to the naked eye. The filter was judged to be valid (that is having a thermomechanical strength acceptable for use as a particulate filter) if no crack was visible after this test.

The main analytical and evaluation data on the filters obtained according to examples 1 to 4 are given in Table 2.

TABLE 2

| Filters obtained | | | | |
|---|---|---|---|---|
| according to | Example 1 | Example 2 | Example 3 | Example 4 |
| Light-off time | 68 | 54 | 68 | 68 |
| (sec) measured at | | | | |
| B: center block of | | | | |
| filter, center of | | | | |
| block | | | | |
| Light-off time (s) | 95 | 74 | 76 | 74 |
| measured at A: | | | | |
| center block of | | | | |
| filter, periphery | | | | |
| of block | | | | |
| Difference in | 27 | 20 | 8 | 6 |
| center/periphery | | | | |
| light-off time (s) | | | | |
| of center block | | | | |
| Light-off time (s) | 78 | 65 | 78 | 78 |
| measured at D: | | | | |
| periphery block of | | | | |
| filter, center of | | | | |
| block | | | | |
| Light-off time (s) | 112 | 86 | 87 | 85 |
| measured at C: | | | | |
| periphery block of | | | | |
| filter, periphery | | | | |
| of block | | | | |
| Difference in | 34 | 21 | 9 | 7 |
| light-off time (s) | | | | |
| at | | | | |
| center/periphery | | | | |
| of peripheral | | | | |
| block | | | | |
| Total light-off | 95 | 77 | 83 | 82 |
| time (s) of | | | | |
| assembled filter | | | | |
| Pressure drop | 13 | 19 | 15 | 16 |
| (mbar) at 300 m³/h | | | | |
| Thermomechanical | No crack | No crack | No crack | No crack |
| test results | observed | observed | observed | observed |

All the filters demonstrated acceptable thermomechanical behavior.

A comparison of the various results given in Table 2 shows that the light-off times measured for the catalytic filters assembled according to the invention are substantially uniform in all parts of the filter. In particular, the difference between the light-off time measured between the periphery of a block and that measured in its central part is less than 10 seconds, regardless of the position of the block in the assembled filter, which had not been observed heretofore.

This unprecedented property is reflected by a very substantially shorter total light-off time of the filter according to the invention, and the pressure drop generated by such an arrangement is also not substantially degraded.

The tests conducted by the applicant have demonstrated that the light-off time of an assembled catalytic filter, measured as the period required for the cold filter to reach a temperature allowing acceptable conversion of the polluting gaseous species, is a function of the heat losses occurring in the jointing cement used to join the monolithic filter blocks. The preceding examples show that, the case in which the cement has a thermal conductivity greater than 0.3 W/m.K at ambient temperature, the increase in the filtration area accessible to the polluted gases at the periphery of the blocks serves according to the invention to make the light-off time uniform in the monolithic elements and thereby to very substantially decrease the total light-off time of the filter.

Obviously, the invention is not limited to the preceding embodiments, and other embodiments are feasible. In particular, the increase in the filtration area from the center of the blocks toward the periphery of the blocks can, according to the invention, be adjusted by any technique known to a person skilled in the art. For example, this increase may be gradual from the center toward the periphery, by gradually adjusting at least one of the parameters included in the group consisting of the channel geometry, the radial density of the channels or the thickness of the channel walls. In particular, any combined adjustment of two or even all three of these parameters, serving to obtain a better uniformity of the light-off time in a monolithic block, is encompassed within the scope of the present invention.

1. A catalytic filter for the treatment of a gas laden with soot and pollutant particulates in a gas phase, comprising a plurality of monolithic honeycomb blocks connected together by a jointing cement, the thermal conductivity of which is greater than 0.3 W/m.K, said blocks comprising a series of adjacent passages or channels having axes parallel to one another separated by porous walls, said passages being blocked by plugs at one or the other of their ends to bound inlet passages opening along a gas intake side and outlet passages opening along a gas discharge side, in such a way that the gas crosses the porous walls, said filter being characterized in that at least the monolithic blocks placed in the central part of the filter, and preferably all of the monolithic blocks, have, along a radial direction, a peripheral portion whose total filtration area is greater than the total filtration area of a central portion of said blocks.

2. The catalytic filter as claimed in claim 1, in which said elements and the jointing cement are based on the same ceramic material.

3. The catalytic filter as claimed in claim 1, in which the thickness of the joint between the blocks is between 0.1 mm and 6 mm.

4. The catalytic filter as claimed in claim 1, in which the jointing cement has a thermal conductivity of between 0.3 and 20 W/m.K.

5. The catalytic filter as claimed in claim 1, in which the density of the channels of the peripheral portion of the blocks is higher than the density of the channels of the central portion of the blocks.

6. The catalytic filter as claimed in claim 5, in which the thickness of the channel walls of the peripheral portion of the blocks is less than the thickness of the channel walls of the central portion of the blocks.

7. The catalytic filter as claimed in claim 1, in which the opening area of the channels of the peripheral portion of the blocks is greater than the opening area of the channels of the central portion of the blocks.

8. The catalytic filter as claimed in claim 7, in which the channels present in the central portion of the blocks have a substantially square cross section and in which the channels of the peripheral portion of the blocks are characterized by a wavy shape.

9. The catalytic filter as claimed in claim 1, comprising at least two distinct and advantageously concentric zones, whose respective filtration areas are different.

10. The catalytic filter as claimed in claim 1, in which the ratio of the area of a peripheral portion to the area of a central portion is between 1.1 and 5.

11. The catalytic filter as claimed in claim 1, in which the filtration area increases gradually from the center toward the periphery of the block.

12. An extrusion die conformed so as to form, by extrusion of a ceramic material, a monolithic block provided with channels suitable for producing a catalytic filter as claimed in claim 1.

13. A method for fabricating a catalytic filter as claimed in claim 1, comprising connecting together a plurality of monolithic honeycomb blocks by a jointing cement, the thermal conductivity of which is greater than 0.3 W/m.K, in which the geometry of the channels and/or their density and/or the thickness of the channel walls is adjusted between the central part and the peripheral part, to shorten the light-off time of the gas conversion reaction.
